(19) United States
(12) Patent Application Publication
(10) Pub. No.: US 2014/0273583 A1
(43) Pub. Date: Sep. 18, 2014

(54) POSITIVE LOCKING CONNECTOR COUPLING

(71) Applicant: Amphenol Corporation, Wallingford, CT (US)

(72) Inventors: Brendon A. Baldwin, Guilford, NY (US); Bryan N. Samowitz, Merrick, NY (US); David Gallusser, Oneonta, NY (US)

(73) Assignee: Amphenol Corporation, Wallingford, CT (US)

(21) Appl. No.: 14/211,952

(22) Filed: Mar. 14, 2014

Related U.S. Application Data
(60) Provisional application No. 61/788,753, filed on Mar. 15, 2013.

(51) Int. Cl. H01R 13/625

(52) U.S. Cl. CPC H01R 13/625
USPC 439/314; 439/312

(57) ABSTRACT

A coupling that includes, a connector body, an interface coupling, a first collar coupled to the interface coupling that has a main body with an inner retaining member including a first set of teeth and a first engagement member, a second collar surrounding the first collar that has at least one second engagement member and is movable axially between a disengaged position when the first and second engagement members arc disengaged and an engaged position when the first and second engagement members are engaged, and a ratchet ring that is received inside of the first collar, that has a second set of teeth, and that is axially moveable with respect to the connector body between a locked position when the first and second sets of teeth are engaged and an unlocked position when the first and second sets of teeth are spaced from one another.

### RELATED APPLICATION

The present application claims priority to U.S. provisional application Ser. No. 61/788,753. filed on Mar. 15, 2013.

### FIELD OF THE INVENTION

The present invention relates to positive locking coupling for an electrical connector or connector accessory, such as a backshell. More specifically, the coupling prevents counter-rotation of the electrical connector when engaged with its mating connector and subject to vibration or shock.

### BACKGROUND OF THE INVENTION

Electrical connector assemblies generally include mating plug and receptacle connectors and backshell assemblies or accessories. Often a threaded nut or collar is used to mate the plug and receptacle connectors. When an electrical connector assembly or accessory is subject to vibration or shock, however, the mating connectors of the assembly often become loose or even decouple. The loosening or decoupling usually occurs because the coupling nut counter rotates, that is it rotates in a direction opposite the mating or locking direction, thereby compromising the integrity of both the mechanical and electrical connection between the mating connectors.

Examples of some prior art couplings for electrical connector assemblies include U.S. Pat. No. 7,914,311 to Gallusser et al.; U.S. Pat. No. 7,905,741 to Wade et al.; U.S. Pat. No. 7,544,085 to Baldwin et al.; U.S. Pat. No. 6,293,595 to Marc et al; U.S. Pat. No. 6,123,563; U.S. Pat. No. 6,086,400 to Fowler; U.S. Pat. No. 5,957,716 to Buckley et al.; U.S. Pat. No. 5,435,760 to Miklos; U.S. Pat. No. 5,399,096 to Quillet et al.; U.S. Pat. No. 4,208,082 to Davies et al.; U.S. Pat. No. 3,917,373 to Peterson; and U.S. Pat. No. 2,728,895 to Quackenbush, the subject Matter of each of which is hereby incorporated by reference.

### SUMMARY OF THE INVENTION

Accordingly, the present invention provides a coupling that includes a connector body, an interface coupling that is rotatable with respect to the connector body and that has an interface portion at an inner surface thereof adapted to engage a mating connector. and a first collar that is coupled to the interface coupling and surrounds the connector body. The first collar has a main body with at least one inner retaining member that includes a first set of teeth and at least one first engagement member at an outer surface thereof. The coupling also includes a second collar that surrounds a portion of the first collar and has at least one second engagement member configured to engage the first engagement member of the first collar. The second collar is movable axially with respect to the connector body between a disengaged position when the first and second engagement members are disengaged and an engaged position when the first and second engagement members are engaged. A ratchet ring is received inside of the first collar and surrounds the connector body. The ratchet ring has a second set of teeth configured to engage the first set of teeth of the first collar. The ratchet ring is axially moveable with respect to the connector body between a locked position when the first and second sets of teeth are engaged and an unlocked position when the first and second sets of teeth are spaced from one another. Wherein when the ratchet ring is in the locked position, the first and second sets of teeth form a ratchet that allows the interface coupling to rotate with respect to the connector body in a mating direction and prevents the interface coupling from rotating with respect to the connector body in a release direction opposite the mating direction.

The present invention may also provide a coupling that includes a connector body, an interface coupling that is rotatable with respect to the connector body and has an interface portion at an inner surface thereof adapted to engage a mating connector, and an inner collar that is coupled to the interface coupling and surrounds the connector body. The inner collar has a main body with at least one inner retaining member that includes a first set of teeth and at least one first engagement member at an outer surface thereof. The coupling also includes an outer collar that surrounds a portion of the inner collar and has at least one second engagement member configured to engage the first engagement member of the inner collar. The outer collar is movable axially with respect to the connector body between a disengaged position when the first and second engagement members are disengaged and an engaged position when the first and second engagement members are engaged. A ratchet ring is received inside of the inner collar and surrounds the connector body. The ratchet ring has a second set of teeth configured to engage the first set of teeth of the inner collar, The ratchet ring is axially moveable with respect to the connector body between a locked position when the first and second sets of teeth are engaged and an unlocked position when the first and second sets of teeth are spaced from one another. An actuating ring is received in the outer collar and surrounds the inner collar. The actuating ring moves the ratchet ring from the locked position to the unlocked position when the outer collar moves from the disengaged position to the engaged position. A biasing member is supported by the connector body adjacent the ratchet ring. The biasing member biasing the ratchet ring in the locked position. Wherein when the ratchet ring is in the locked position, the first and second sets of teeth form a ratchet that allows the interface coupling to rotate with respect to the connector body in a mating direction and prevents the interface coupling from rotating with respect to the connector body in a release direction opposite said mating direction.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an exploded perspective view of a coupling according to an embodiment of the present invention;

FIGS. 2A and 2B are cross-sectional views of the coupling illustrated in FIG. 1, showing the coupling assembled to a backshell connector body in a locked position;

FIG. 3 is a perspective sectional view of the coupling illustrated in FIG. 1, showing the coupling in the locked position; and

FIG. 4 is a perspective sectional view of the coupling similar to FIG. 3, except showing the coupling in the unlocked position.

### DETAILED DESCRIPTION OF THE EXEMPLARY EMBODIMENTS

Referring to FIGS. 1, 2A, 2B, 3 and 4, the present invention relates to a positive locking coupling 100 for an electrical connector or connector accessory, such as a backshell. The coupling 100 preferably provides a one-way ratchet engagement to provide positive locking such that the connector components of the assembly can only be disengaged manually. The coupling 100 is preferably disposed on a connector body 102, which may be the body or shell of a connector, backshell, accessory, and the like. The coupling 100 is advantageously designed to be front loaded onto that body. The coupling 100, in accordance with an exemplary embodiment of the present invention, generally includes an interface coupling 104, an inner collar 106, an outer ring 108, a ratchet ring 110, an actuating ring 112, and a biasing member 114.

The interface coupling 104 rotates with respect to an interface end 103 of the backshell connector body 102 for mating to the mating connector component. The backshell connector body 102 may include a grounding ring 192 secured to its interface end 103 via an attachment ring 194 by an interference fit, for example, or by any known manner of attachment. The interface coupling 104 is axially stationary with respect to the backshell connector body 102. An interface portion 120 of the interface coupling 104 may include threads 122 at its inner surface for engaging corresponding threads of the mating connector component. That is, the interface coupling 104 may rotate in a mating direction (e.g. counter-clockwise when viewing the backshell connector body 102 from its interface end 103) to threadably engage the mating connector component. The portion 124 of the interface coupling 104 opposite the interface portion 120 includes one or more keys 126 (FIG. 1) on the outer surface thereof. The one or more keys 126 engage corresponding keyways 128 (FIG. 1) in the inner surface of the inner collar 106 such that the portion 124 of the interface coupling 104 is received in the end of the inner collar 106. The engagement of the keys 126 and the keyways 128 interlock the interface coupling 104 and the inner coupling 106 such that those components rotate together.

As best seen in FIG. 1, the interface coupling 104 includes an outwardly extending annular flange 130 that is positioned between the interface portion 120 and the portion 124. The flange 130 acts a stop against the end of the inner collar 106, as seen in FIGS. 2A and 2B. Adjacent the keys 126 is an annular groove 132 adapted to receive a retaining ring 134 for coupling the interface coupling 104 and the inner collar 106.

The inner collar 106 surrounds the connector body 102 such that the inner collar 106 is retained on and is axially stationary with respect to the connector body 102. The inner collar 106 includes a main body 140 that receives the end portion of the interface coupling 104. The main body 140 may include one or more engagement members 142. The engagement members 142 may be a bayonet ramp, for example, that is formed in the outer surface of the inner collar 104, as seen in FIG. 1. Each bayonet ramp may have an entrance 144 and an end 146 opposite the entrance 144.

Extending from the main body 140 away from the interface coupling 104 are one or more spaced arms 150. The spaced arms 150 are preferably arranged in a ring formation and are preferably resilient to facilitate engagement with the connector body 102. Each of the arms 150 may include a catch end 152 that extends from its distal end that is configured to engage or catch a shoulder or flange of the connector body 102, as seen in FIG. 2A. The arms may vary in width but are preferably substantially the same length. In a preferred embodiment, eight arms are provided. However, more or less arms may be provided to accommodate the shell size of the connector body.

As seen in FIGS. 3 and 4, inside of the inner collar's main body 140 is one or more retaining segments 160. The retaining segments 160 are preferably arranged in a spaced relationship around the inner surface of the main body 140. Each retaining segment 160 has a plurality of teeth 162 facing in an axial direction toward the interface coupling 104. The teeth 162 are configured to engage the ratchet ring 110 and provide a ratchet feature to the inner collar 106. One or more of the arms 150 may extend from the retaining segments 160. In a preferred embodiment, two arms 150 extend from opposite end portions of each retaining segment 160. Between the retaining segments 160 are slots 164 that are adapted to engage the actuating ring 112.

The outer collar 108 surrounds a substantially portion of the inner collar 104 such that the arms 150 of the inner collar 106 extend beyond the end of the outer collar 108. The outer collar 108 is configured to rotate with respect to both the inner collar 106 and the backshell connector body 102. The outer collar 106 includes one or more engagement members 180 on the inner surface of the outer collar 106, as seen in FIGS. 2A, 3, and 4. The engagement members 180 preferably correspond to the engagement members 142 of the inner collar 104. For example, the engagement members 180 may be inwardly extending detents that engage a respective ramp 142 on the outer surface of the inner collar 106. The detents 180 may be centrally located within the outer collar 108.

The outer collar 108 is configured to move axially with respect to the connector body 102 between a disengaged position where the engagement members 142 and 180 of the inner and outer collars 106 and 108 are not fully engaged and an engaged position where the engagement members 142 and 180 of the inner and outer collars 106 and 108 are fully engaged with one another. That is, in the disengaged position, the detents 180 of the outer collar 108 are received in the entrance 144 of the respective ramps 142 on the inner collar 106. As the outer collar 108 rotates and the detents 180 move along the respective ramps 142, the outer collar 108 moves axially toward the interface coupling 104 until the detents 180 rest in the ends 146 of the respective ramps 142. When the detents 180 of the outer collar 108 are received in the ends 146 of the respective ramps 142 on the inner collar 106, the outer collar 108 is fully engaged with the inner collar 106 and is prevent from moving further axially. The outer collar 108 may include an outer gripping surface 182 to facilitate gripping and rotation of the collar 108.

The ratchet ring 110 is disposed around the connector body 102 inside of the main body 140 of the inner collar 106, as seen in FIGS. 3 and 4. The ratchet ring 110 includes a ring body with first and second sides 170 and 172. The first side 170 forms an abutment surface that abuts the biasing member 114. The second side 172 includes a plurality of teeth facing in an axial direction away from the abutment surface and configured to engage the teeth 172 of the segments 160, as best seen in FIG. 3. The teeth 172 of the ratchet ring 110 and the teeth 162 of the inner collar 106 are designed to form a one-way ratchet when engaged. The ratchet ring 110 is moveable axially with respect to the backshell connector body 102 between locked and unlocked positions. In the locked position (FIG. 3), the teeth 174 of the ratchet ring 110 are engaged with the teeth 162 of the inner collar 106. The biasing member 114 pushes against the abutment surface of the first side 170 of the ratchet ring 110 to bias the ratchet member 110 in its locked position. The biasing member 114 may be one or more wave springs or the like, for example. In the unlocked position, the ratchet ring 110 moves axially against the bias of the biasing member 114, via the actuating ring 112, toward the interface coupling 104 to disengage and space the teeth 172 from the teeth 162. as seen in FIG. 4.

The actuating ring 112 is supported inside of the outer collar 106, preferably in an inner groove 184 thereof, such that the actuating ring 112 surrounds the inner collar 106, as seen in FIG. 213. A plurality of inner tabs 190 extend inwardly from the ring body of the actuating ring 112. The tabs 190 are sized and annularly spaced to fit into the slots 164 between the retaining segments 160 of the inner collar 106 such that the tabs 150 can move axially within the respective slots 164.

To mate the connector component to a mating connector component using the coupling 100 of the present invention, the outer collar 108 is disposed in its disengaged position with respect to the inner collar 106 where the detents 180 are at the entrance 144 of the bayonet ramps 142 on the surface of the inner collar 106. The ratchet ring 110 is in its locked position where its teeth 172 are engaged with the teeth 162 of the inner collar in a one-way ratchet engagement. That allows the interface coupling 104, which is engaged to the inner collar 106 by the retaining ring 134, to be rotated with respect to the connector body 102 in the mating direction such that the threads 122 can engage corresponding threads on the mating connector. The interface coupling 104 is rotated in that mating direction until tight.

The engagement of the teeth 162 and 172 of the inner collar 108 and the ratchet ring 110, while allowing the interface coupling 104 to rotate in the mating direction, also prevent the interface coupling from rotating in the release direction opposite the mating direction. That creates a secure connection between the mated connector components and prevents loosening of the components. even under conditions such as vibration.

The coupling 100 may be manually unlocked to allow the interface coupling 104 and the inner collar 106 to rotate in the release direction with respect to the backshell connector body 102 when desired. The manual unlocking allows decoupling of the threads 122 of the inner collar 104 from the mating connector. To unlock the coupling 100, the outer collar 108 is moved from its disengaged position to its engaged position with respect to the inner collar 108. In particular, the outer collar 108 is rotated with respect to the inner collar 106 and the backshell connector body 102 such that its detents 180 ride along the respective bayonets channels 142, thereby pulling and moving the outer collar 108 axially toward the interface coupling 104 until the detents reside at the ends 146 of the channels 142. As the outer collar 108 moves axially toward to the inner collar 106 to its engaged position, the actuating ring 112 residing inside of the outer collar 108 engages and pushes against the ratchet ring 110 to push apart and space the teeth 172 of the ratchet ring 110 from the teeth 162 of the inner collar 106. In particular, the tabs 190 of the actuating ring 112 move in respective slots 164 of the inner collar 106 to abut the teeth 172 of the ratchet ring 110. That moves the ratchet ring 110 axially with respect to the connector body 102 toward the interface coupling 104 to its unlocked position. Once the ratchet ring 110 is in the unlocked position, the interface coupling 104 and the inner collar 106 can be rotated in the release direction to disengage the threads 122 from the mating connector component.

While a particular embodiment has been chosen to illustrate the invention, it will be understood by those skilled in the art that various changes and modifications can be made therein without departing from the scope of the invention as defined in the appended claims. For example, any type of known engagement may be used at the interface portion 120 of the inner collar 104 and is not limited to threads. Any type of engagement members 142 and 180 may be used to engage the inner and outer collars 106 and 108 and are not limited to a bayonet engagement. Also, the corresponding detents and channels of the bayonet engagement may be located on either the inner collar or the outer collar. Also, the biasing member is not limited to a wave spring and may be any type of biasing mechanism, such as a compression spring.

What is claimed is:

1. A coupling, comprising:
a connector body;
an interface coupling rotatable with respect to said connector body and having an interface portion at an inner surface thereof adapted to engage a mating connector:
a first collar coupled to said interface coupling and surrounding said connector body, said first collar having a main body, said main body having at least one inner retaining member including a first set of teeth and at least one first engagement member at an outer surface thereof;
a second collar surrounding a portion of said first collar and having at least one second engagement member configured to engage said first engagement member of said first collar, said second collar being movable axially with respect to said connector body between a disengaged position when said first and second engagement members are disengaged and an engaged position when said first and second engagement members are engaged;
a ratchet ring received inside of said first collar and surrounding said connector body, said ratchet ring having a second set of teeth configured to engage said first set of teeth of said first collar, said ratchet ring being axially moveable with respect to said connector body between a locked position when said first and second sets of teeth are engaged and an unlocked position when said first and second sets of teeth are spaced from one another,
wherein when said ratchet ring is in said locked position, said first and second sets of teeth form a ratchet that allows said interface coupling to rotate with respect to said connector body in a mating direction and prevents said interface coupling from rotating with respect to said connector body in a release direction opposite said mating direction.

2. A coupling according to claim 1, further comprising a biasing member supported by said connector body adjacent said ratchet ring, said biasing member biasing said ratchet ring in said locked position.

3. A coupling according to claim 1, wherein an actuating ring received in said second collar and surrounding said inner collar, said actuating ring moving said ratchet ring from said locked position to said unlocked position when said second collar moves from said disengaged position to said engaged position.

4. A coupling according to claim 3, wherein
said actuating member including at least one inwardly extending tab residing in a corresponding slot in said second portion of said retaining member, said at least one tab being movable within said slot to push said ratchet ring from said locked position to said unlocked position.

5. A coupling according to claim 1, wherein
said main body of said inner collar including at least one finger for catching a portion on an outer surface of said connector body.

6. A coupling according to claim 1, wherein
said first set of teeth of said inner collar face in an axial direction toward said interface portion of said interface coupling.

7. A coupling according to claim 6, wherein
said ratchet ring includes opposite first and second sides, said first side is an abutment surface and said second set of teeth are disposed on said second side such that said second set of teeth face in an axial direction away from said abutment surface and toward said first set of teeth of said inner collar.

8. A coupling according to claim 1, wherein
said at least one first engagement member of said first collar is a bayonet ramp, said bayonet ramp having a entrance and an end opposite said entrance: and
said at least one second engagement member of said second collar is a bayonet detent such that said bayonet detent is received in said end of said bayonet ramp when said second collar is in said engaged position.

9. A coupling according to claim 1, wherein
said interface portion of said first collar includes threads on an inner surface thereof for engaging a mating connector.

10. A coupling according to claim 1, further comprising
a retaining ring received between said interface coupling and said first collar thereby coupling said interface coupling and said first collar.

11. A coupling according to claim 1, wherein
said interface coupling including at least one key on an outer surface thereof; and
said inner collar including at least one keyway for receiving said at least on key.

12. A coupling, comprising:
a connector body;
an interface coupling rotatable with respect to said connector body and having an interface portion at an inner surface thereof adapted to engage a mating connector;
an inner collar coupled to said interface coupling and surrounding said connector body, said inner collar having a main body, said main body having at least one inner retaining member including a first set of teeth and at least one first engagement member at an outer surface thereof;
an outer collar surrounding a portion of said inner collar and having at least one second engagement member configured to engage said first engagement member of said inner collar, said outer collar being movable axially with respect to said connector body between a disengaged position when said first and second engagement members are disengaged and an engaged position when said first and second engagement members are engaged;
a ratchet ring received inside of said inner collar and surrounding said connector body, said ratchet ring having a second set of teeth configured to engage said first set of teeth of said inner collar, said ratchet ring being axially moveable with respect to said connector body between a locked position when said first and second sets of teeth are engaged and an unlocked position when said first and second sets of teeth are spaced from one another;
an actuating ring received in said outer collar and surrounding said inner collar, said actuating ring moving said ratchet ring from said locked position to said unlocked position when said outer collar moves from said disengaged position to said engaged position: and
a biasing member supported by said connector body adjacent said ratchet ring, said biasing member biasing said ratchet ring in said locked position,
wherein when said ratchet ring is in said locked position, said first and second sets of teeth form a ratchet that allows said interface coupling to rotate with respect to said connector body in a mating direction and prevents said interface coupling from rotating with respect to said connector body in a release direction opposite said mating direction.

13. A coupling according to claim 12, wherein
said inner collar includes a plurality of slots; and
said actuating ring including a plurality of inwardly extending tabs, each of said tabs is received in one of said plurality of slots.

14. A coupling according to claim 13, wherein
said plurality of slots of said inner collar being defined by a plurality of arms extending from said main body away from said interface coupling.

15. A coupling according to claim 14, wherein
each of said arms including a catch at an end thereof for engaging a flange of said connector body.

16. A coupling according to claim 12, wherein
said inner collar includes a plurality of keyways adapted to receive corresponding keys on an outer surface of said interface coupling.

17. A coupling according to claim 12, wherein
said ratchet ring includes opposite first and second sides, said first side is an abutment surface that abuts said biasing member and said second set of teeth are disposed on said second side such that said second set of teeth face away from said abutment surface.

18. A coupling according to claim 12, wherein
said at least one first engagement member of said inner collar is a bayonet ramp, said bayonet ramp having a entrance and an end opposite said entrance; and
said at least one second engagement member of said outer collar is a bayonet detent such that said bayonet detent is received in said end of said bayonet ramp when said second collar is in said engaged position.

19. A coupling according to claim 12, wherein
said interface portion of said interface coupling includes threads on an inner surface thereof for engaging the mating connector.

20. A coupling according to claim 12, wherein
said biasing member is a wave spring.

21. A coupling according to claim 12, wherein
said connector body includes a grounding ring at an interface end of the connector body.

22. A coupling according to claim 21, wherein
said grounding ring is coupled to said interface by an interference fit via an attachment ring.
